(19) United States
(12) Patent Application Publication
(10) Pub. No.: US 2008/0196773 A1
(43) Pub. Date: Aug. 21, 2008

(54) Ventline control valve assembly

(75) Inventor: Robert B. Franconi, New Hartford, CT (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International, Inc.

(21) Appl. No.: 11/707,843

(22) Filed: Feb. 16, 2007

(51) Int. Cl. F16K 31/124

(52) U.S. Cl. 137/492.5; 251/28; 137/488

(57) ABSTRACT

A valve assembly includes a valve body, a primary valve, and a pilot valve. The valve body includes an inner surface that forms a chamber, a first inlet receiving fluid from a first source and having a port fluidly communicating with the chamber, a restriction orifice receiving fluid from the first source, a second inlet receiving fluid from a second source, a vent outlet line, and an outlet. The primary valve moves between an open position, in which the port and restriction orifice fluidly communicate with the outlet, and a closed position, in which the restriction orifice, but not the port, fluidly communicates with the outlet. The pilot valve moves in response to a differential pressure between the first and second sources, between a first position, in which the chamber fluidly communicates with the vent orifice, and a second position, in which the chamber fluidly communicates instead with the second source.

### TECHNICAL FIELD

The present invention generally relates to a valve assembly, and more particularly relates to a valve assembly for controlling pressure between a first pressurized fluid source and a second pressurized fluid source.

### BACKGROUND

Valves are used to control gases or other fluids in various types of apparatus and vehicles, such as aircraft. There are many different types of valves used in aircraft, other vehicles, and other apparatus, such as ball valves, control valves, and solenoid valves, among others. By way of example only, control valves regulate the flow or pressure of fluid, for example by opening, closing, or partially obstructing various passageways.

Among various other applications, control valves may be utilized in bearing lubrication systems for gas turbine engines. Such lubrication systems may supply oil or another lubricant to bearings, while also receiving fluid flow at different pressures from multiple fluid sources via pressurization lines, resulting in a pressure differential. It may be desirable to control such a pressure differential with a control valve adapted to close during high pressure operation, to thereby limit the delta pressure across bearing seals and thus improve bearing seal life and reduce oil consumption. However, it may be difficult to implement such a control valve for a bearing lubrication system which effectively maintains a pressure differential while keeping the pressurization lines free of any unwanted oil or other contaminants.

Accordingly, there is a need for a control valve that can be used in a bearing lubrication system, and that effectively maintains a pressure differential between multiple fluid pressure sources while keeping the pressurization lines free of any unwanted oil or other contaminants. The present invention addresses one or more of these needs.

### BRIEF SUMMARY

An apparatus is provided for a valve assembly. In one embodiment, and by way of example only, the valve assembly comprises a valve body, a primary valve, and a pilot valve. The valve body includes a first inlet flow passage, a second inlet flow passage, a flow restriction orifice, an outlet flow passage, and an inner surface that defines a primary valve chamber. The first inlet flow passage has an inlet port to receive fluid from a first pressurized fluid source and an outlet port in fluid communication with the primary valve chamber. The flow restriction orifice is adapted to receive fluid flow from the first pressurized fluid source, and the second inlet flow passage is adapted to receive fluid flow from a second pressurized fluid source. The primary valve is disposed in the primary valve chamber, and is configured to move between an open position and a closed position. When the primary valve is in the open position, the first inlet flow passage outlet port and the flow restriction orifice are both in fluid communication with the outlet flow passage. When the primary valve is in the closed position, the first inlet flow passage outlet port is fluidly isolated from the outlet flow passage and the flow restriction orifice is in fluid communication with the outlet flow passage. The pilot valve is disposed in the valve body, and is movable, at least partially in response to a differential pressure between the first and second pressurized fluid sources, between a first position and a second position. When the pilot valve is in the first position, the primary valve chamber is in fluid communication with the vent outlet and fluidly isolated from the second pressurized fluid source. When the pilot valve is in the second position, the portion of the primary valve chamber is in fluid communication with the second pressurized fluid source and fluidly isolated from the vent outlet.

In another embodiment, and by way of example only, the valve assembly comprises a valve body, a primary valve, and a pilot valve. The valve body includes a first inlet flow passage, a second inlet flow passage, a third inlet flow passage, a flow restriction orifice, a vent flow passage, an outlet flow passage, and an inner surface that defines a primary valve chamber. The first inlet flow passage has an inlet port adapted to receive fluid flow from a first pressurized fluid source and an outlet port in fluid communication with the primary valve chamber. The flow restriction and the second inlet flow passage are each adapted to receive fluid flow from the first pressurized fluid source, and the third inlet flow passage is adapted to receive fluid flow from a second pressurized fluid source. The primary valve is disposed in the primary valve chamber, and is configured to move between an open position and a closed position. When the primary valve is in the open position, the first inlet flow passage and the flow restriction orifice are both in fluid communication with the outlet flow passage. When the primary valve is in the closed position, the first inlet flow passage is fluidly isolated from the outlet flow passage and the flow restriction orifice is in fluid communication with the outlet flow passage. The pilot valve is disposed in the valve body, and is movable, at least partially in response to a differential pressure between the first and second pressurized fluid sources, between a first position and a second position. When the pilot valve is in the first position, the primary valve chamber is in fluid communication with the valve outlet and fluidly isolated from the second pressurized fluid source. When the pilot valve is in the second position, the portion of the primary valve chamber is in fluid communication with the second pressurized fluid source and fluidly isolated from the vent orifice.

In yet another embodiment, and by way of example only, the valve assembly is for controlling pressure between a first pressurized fluid source and a second pressurized fluid source, and the valve assembly comprises a valve body, a primary valve, and a pilot valve. The valve body includes a first inlet flow passage, a second inlet flow passage, a flow restriction orifice, a vent flow passage, an outlet flow passage, and an inner surface that defines a primary valve chamber. The first inlet flow passage has an inlet port adapted to receive fluid flow from a first pressurized fluid source and an outlet port in fluid communication with the primary valve chamber. The flow restriction orifice is adapted to receive fluid flow from the first pressurized fluid source, and the second inlet flow passage is adapted to receive fluid flow from the second pressurized fluid source. The primary valve is disposed at least partially within the primary valve chamber, and includes a spring and a poppet. The spring is disposed in the valve body. The poppet is disposed in the primary valve chamber. The poppet is configured to receive, in at least substantially opposite directions a closing force from fluid flow from the second pressurized fluid source, and a bias force from the spring. The poppet is movable by the opposing closing force and bias force between an open position and a closed position. When the poppet is in the open position, the first inlet flow passage outlet port and the flow restriction orifice are both in fluid communication with the outlet flow passage. When the poppet is in the closed position, the first inlet flow passage outlet port is fluidly isolated from the outlet flow passage and the flow restriction orifice is in fluid communication with the outlet flow passage. The pilot valve is disposed in the valve body. The pilot valve includes a pilot valve element that is movable, at least partially in response to a differential pressure between the first and second pressurized fluid sources, between a first position and a second position. When the pilot valve element is in the first position, a portion of the primary valve chamber is in fluid communication with the vent outlet and fluidly isolated from the second pressurized fluid source. When the pilot valve element is in the second position, the portion of the primary valve chamber is in fluid communication with the second pressurized fluid source and fluidly isolated from the vent outlet.

### BRIEF DESCRIPTION OF THE DRAWINGS

The present invention will hereinafter be described in conjunction with the following drawing figures, wherein like numerals denote like elements, and

FIG. 1 is a schematic drawing of an exemplary bearing lubrication system for a gas turbine engine;

FIG. 2 is a schematic drawing of an exemplary valve assembly that can be used in the bearing lubrication system of FIG. 1; and

FIG. 3 is a schematic drawing of another exemplary valve assembly that can be used in the bearing lubrication system for a gas turbine engine.

### DETAILED DESCRIPTION OF A PREFERRED EMBODIMENT

The following detailed description of the invention is merely exemplary in nature and is not intended to limit the invention or the application and uses of the invention. Furthermore, there is no intention to be bound by any theory presented in the preceding background of the invention or the following detailed description of the invention.

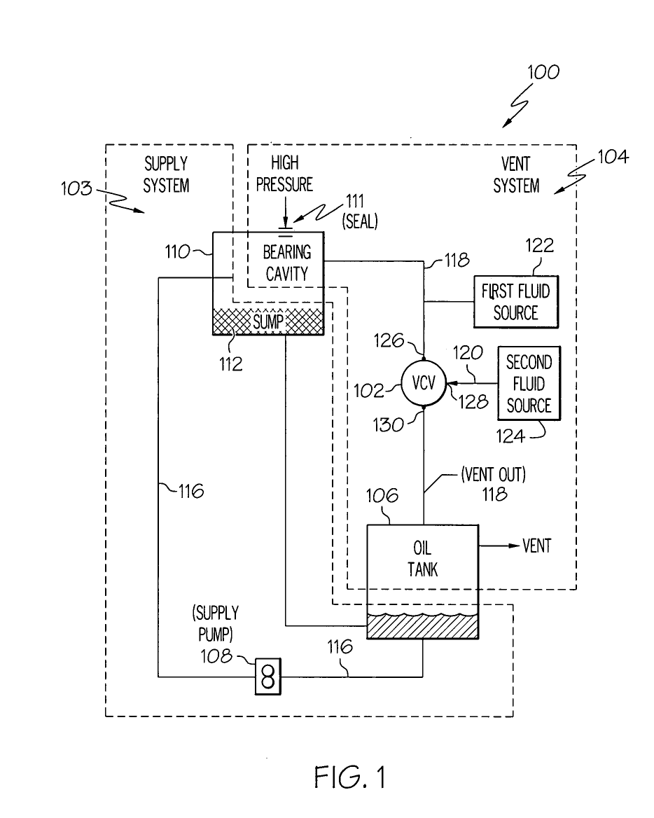

FIG. 1 is a schematic drawing of a portion of a bearing lubrication system 100 for a gas turbine engine, using a ventline control valve (VCV) assembly 102. Before describing the bearing lubrication system 100 further, it is noted that, for clarity, the entire lubrication system flow circuit is not depicted. Rather, only those portions that are sufficient to describe an exemplary environment in which the VCV assembly 102 may be used.

The bearing lubrication system 100 includes a supply subsystem 103 and a vent subsystem 104. The supply subsystem 103 includes an oil tank 106, a supply pump 108, and a bearing cavity 110. The oil tank 106 stores oil, or another suitable lubricant, that is supplied at least to the bearing cavity 110 and to various non-depicted components and bearings through the supply subsystem 103. The bearing cavity 110 includes non-depicted bearings, one or more bearing seals 111, and a sump 112. The sump 112 receives and temporarily stores oil that is supplied to the bearing cavity 110 via the supply pump 108.

The supply pump 108 pumps the oil or other suitable lubricant from the oil tank 106 to the bearing cavity 110 via a supply line 116. It will be appreciated that the supply subsystem 103 may also include various other non-depicted features, and/or may supply oil or other suitable lubricants from multiple oil tanks 106 to multiple bearing cavities 110 or other devices. It will similarly be appreciated that the supply subsystem 103 may include multiple supply pumps 108, multiple supply lines 116, and/or multiple sumps 112.

The vent subsystem 104 includes the above-mentioned VCV assembly 102, as well as one or more vent lines 118, a pressurization line 120, a first pressurized fluid source 122, and a second pressurized fluid source 124. The vent lines 118 fluidly communicate the bearing cavity 110 with the first pressurized fluid source 122 and the VCV assembly 102, and fluidly communicate the oil tank 106 with the VCV assembly 102. The pressurization line 120 fluidly communicates the second pressurized fluid source 124 with the VCV assembly 102.

The VCV assembly 102 includes one or more first inlets 126, a second inlet 128, and an outlet 130. The first inlet(s) 126 is (are) coupled to at least one of the vent lines 118, and are thus in fluid communication with the first pressurized fluid source 122 and, in the depicted embodiment, the bearing cavity 110. The second inlet 128 is in fluid communication with the second pressurized fluid source 124, and the outlet 130 is in fluid communication with the oil tank 106 via another one of the vent lines 118. The VCV assembly 102 limits the pressure differential in the bearing lubrication system 100 to thereby limit the differential pressure across the bearing seal 111.

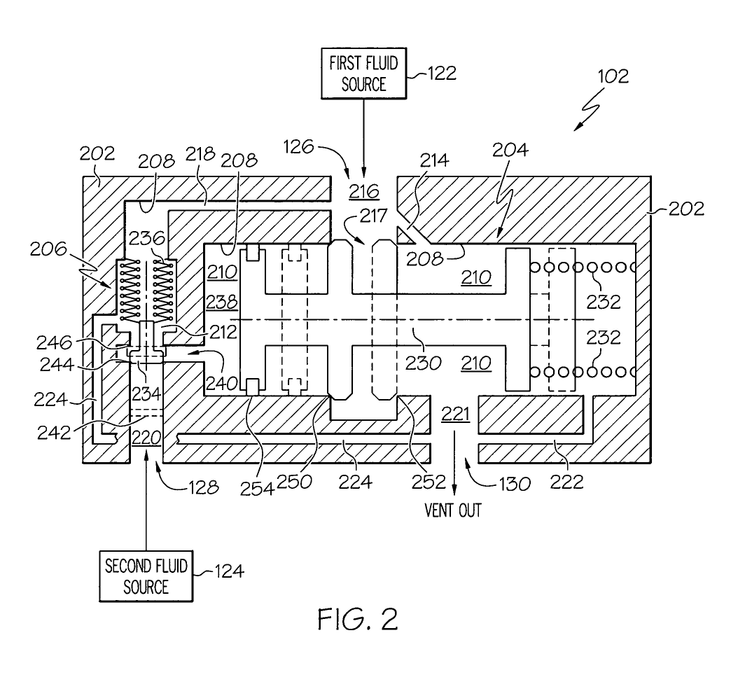

Turning now to FIG. 2, which depicts schematically an embodiment of the VCV assembly. The VCV assembly 102 includes a valve body 202, a primary valve 204, and a pilot valve 206. In this embodiment, the valve body 202 includes the previously mentioned first inlet 126 (only one in this embodiment), the second inlet 128, and the outlet 130, and additionally includes an inner surface 208 that defines a primary valve chamber 210 and a pilot valve chamber 212, and a flow restriction orifice 214. The valve body 202 is preferably constructed of stainless steel, but may also be made of any number of other different materials.

The first inlet 126 is adapted to receive fluid flow from a first pressurized fluid source such as, for example, the above-mentioned first pressurized fluid source 122, and is in fluid communication with both the primary valve chamber 210 and the pilot valve bellows 206 via the first pilot valve chamber flow passage 218. More specifically, at least in the depicted embodiment, the first inlet 126 is fluid isolated from the primary valve chamber 210 via a first primary valve seat 250 or in the actuated position by a piston seal 254. The second inlet 128 is adapted to receive fluid flow from a second pressurized fluid source such as, for example, the above-mentioned second pressurized fluid source 124, and is in fluid communication with the pilot valve poppet 234 via a second pilot valve chamber inlet flow passage 220.

The outlet 130 is in fluid communication with both the primary valve chamber 210 and the pilot valve chamber 212. More specifically, at least in the depicted embodiment, the outlet 130 is in fluid communication with the primary valve chamber 210 via a primary valve chamber outlet flow passage 221 and a primary valve chamber vent flow passage 222, and is in fluid communication with the pilot valve chamber 212 via a pilot valve chamber vent flow passage 224. In the embodiment of FIG. 2, the pilot valve chamber vent flow passage 224 extends between the pilot valve chamber 212 and the outlet 130, but this may vary in other embodiments.

The flow restriction orifice 214 fluidly communicates the first inlet 126 and the outlet 130 and allows at least a limited amount of fluid flow therebetween at all times. In the embodiment depicted in FIG. 2, the flow restriction orifice 214 extends between a portion of the primary valve chamber inlet flow passage 216 and the primary valve chamber 210; however, this may vary. For example, in other embodiments, the flow restriction orifice 214 may be directly coupled to the first pressurized fluid source 122. Similarly, the number of primary valve chamber inlet flow passages 216 and/or primary valve chamber inlet flow passage outlet ports 217 may vary.

The primary valve 204 is at least partially disposed within the primary valve chamber 210, and includes a poppet 230 and a spring 232. The poppet 230 is movable between an open position and a closed position. When the poppet 230 is in the normally open position (shown in FIG. 2), the primary valve chamber inlet flow passage outlet port 217 and the flow restriction orifice 214 are both in fluid communication with the outlet 130 via the primary valve chamber 210. Conversely, when the poppet 230 is in the closed position (shown in phantom in FIG. 2), the primary valve chamber inlet flow passage outlet port 217 is fluidly isolated from the outlet 130, while the flow restriction orifice 214 remains in fluid communication with the outlet 130 via the primary valve chamber 210. The spring 232 is disposed in the valve body 202, and supplies a bias force that urges the poppet 230 toward the open position. The poppet 230 is preferably made of stainless steel, but it will be appreciated that the poppet 230 may also take any one of a number of different shapes and be made of any one of a number of different types of material.

The first primary valve seat 250 seats the poppet 230 when the poppet 230 is in the open position, and a second primary valve seat 252 seats the poppet 230 when the poppet 230 is in the closed position. Accordingly, the poppet 230 seats on a conical metal interface in both the open and closed positions. Preferably the first and second primary valve seats 250, 252 are made of stainless steel and have sharp edges. The first and second primary valve seats 250, 252 provide improved, consistent sealing even in the presence of any accumulated contamination. For example, when the poppet 230 is in the open position, the first primary valve seat 250 prevents reverse flow past the primary valve piston seal 254, thus minimizing contamination, thus enhancing durability and reliability.

The pilot valve 206 is disposed in the pilot valve chamber 212, and includes a pilot valve element 234 and a bellows assembly 236. The pilot valve element 234 is movable, at least partially in response to a differential pressure between the first and second pressurized fluid sources 122, 124, between a first position and a second position. The bellows assembly 236 is coupled between the valve body 202 and the pilot valve element 234, and is configured to supply a bias force that urges the pilot valve element 234 toward the first position. When the pilot valve element 234 is in the first position (shown in FIG. 2), a portion 238 of the primary valve chamber 210 is in fluid communication with the outlet 130, via a connecting flow passage 240 and 224, and is fluidly isolated from the second pressurized fluid source 124. When the pilot valve element 234 is in the second position (depicted in phantom in FIG. 2), this same portion 238 of the primary valve chamber 210 is in fluid communication with the second pressurized fluid source 124, via the connecting flow passage 240, and is fluidly isolated from the pilot valve chamber vent line 224.

Specifically, the pilot valve element 234 moves from the first position to the second position when a force exerted thereon from the second pressurized fluid source 124 exceeds the sum of the bias force supplied from the bellows assembly 236 and the force exerted thereon from the first pressurized fluid source 122. Conversely, the pilot valve element 234 moves from the second position to the first position when the sum of the bias force supplied from the bellows assembly 236 and the force exerted thereon from the first pressurized fluid source 122 exceeds the force exerted thereon from the second pressurized fluid source 124. Similar to the poppet 230, the pilot valve element 234 is preferably made of stainless steel, but it will be appreciated that the pilot valve element 234 may also take any one of a number of different shapes and be made of any one of a number of different types of material. The bellows assembly 236 preferably has a low spring rate and does not allow any leakage therethrough, so as to minimize oil entry into the pilot valve 206 and reduce any potential for coking in the VCV pilot valve assembly 206 and seating surfaces 244 and 246. Accordingly, the first fluid source sense pressure 122 via sense line 218 is nonflowing, thereby preventing oil and/or other contaminants from affecting seating and/or guide surfaces for the pilot valve 206. It will be appreciated that the bellows assembly 236 spring rate may vary in different embodiments.

Additionally, as shown in FIG. 2, the second pilot valve chamber inlet flow passage 220 preferably includes a screen 242, a first seat 244, and a second seat 246. The screen 242 at least partially restricts certain types of foreign objects and/or other contaminants, from passing through the second pilot valve chamber inlet flow passage 220. The first seat 244 seats the pilot valve element 234 when it is in the first position, and the second seat 246 seats the pilot valve element 234 when it is in the second position. Preferably the first and second seats 244, 246 are made of stainless steel and have sharp edges to help cut through any minute contamination buildup that has penetrated the screen 242, provide enhanced sealing, and prevent reverse inlet pressure flow. However, it will be appreciated that the first and second seats 244, 246 may take any one of a number of different shapes and be made of any one of a number of different types of material.

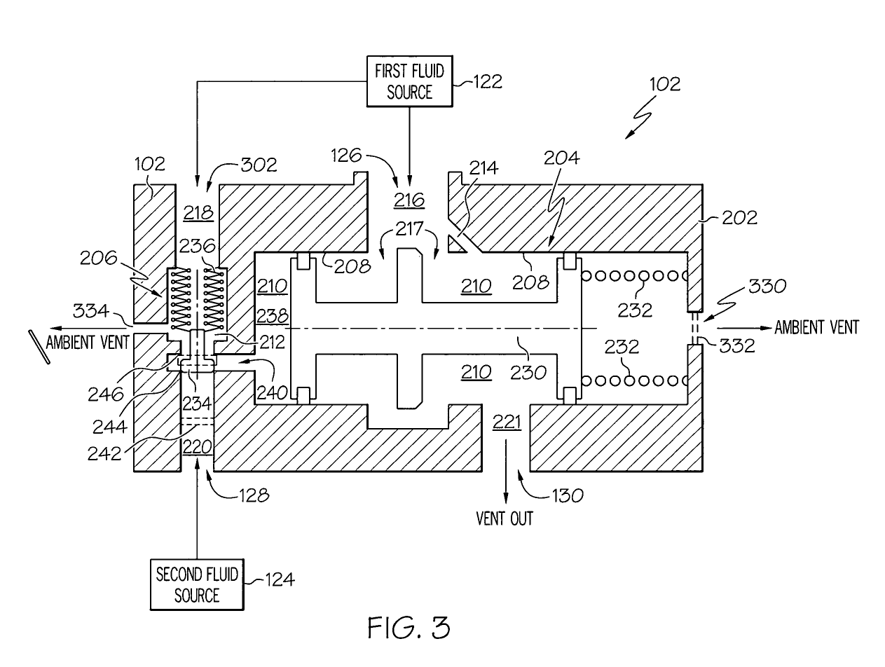

FIG. 3 depicts an alternative embodiment of the VCV assembly 102. The embodiment depicted in FIG. 3 is similar to that depicted in FIG. 2, but with a few differences. Specifically, in the embodiment of FIG. 3, the pilot valve chamber 212 is not in fluid communication with the first inlet 126. Rather, the valve body 202 includes a separate pilot valve chamber inlet 302, which is adapted to receive fluid flow from the first pressurized fluid source 122. Additionally, in the embodiment of FIG. 3, the primary valve chamber 210 is vented to ambient via a second outlet 330 formed in the valve body 202, which may include a second screen 332 to prevent entry of contaminants. Also, the pilot valve chamber 212 is vented to ambient via a third outlet 334.

It will be appreciated that other variations may also be included in the VCV assembly 102, and/or that various other features may be included. For example, the primary valve 204 may include a plurality of non-metallic guide rings to help prevent contamination and reduce wear due to sliding, a non-depicted retainer for the spring 232, a non-depicted non-metallic piston ring to help reduce leakage and friction, a plurality of non-depicted o-rings for improved sealing, and/or various other features. The pilot valve 206 may also include a number of additional features, such as a plurality of non-depicted o-rings and shims to help prevent internal and external leakage and provides a means to calibrate, a non-depicted retainer for the screen 242, a plurality of non-depicted cap screws near the second inlet 128, and/or various other features.

Having generally described the VCV assembly 102, a more detailed description of the operation of a particular embodiment of the VCV assembly 102 will now be described with reference to the embodiment of FIG. 2, assuming that the pilot valve element 234 is in the first position and the poppet 230 is in the open position, as shown in FIG. 2. In this state, fluid from the second pressurized fluid source 124 is blocked from entering the connecting flow passage 240, and fluid, if any, in the portion 238 of the primary valve chamber 210 flows through the connecting flow passage 240 and is vented to the outlet 130 via the pilot valve chamber vent flow passage 224. The primary valve chamber inlet flow passage outlet port 217 and the flow restriction orifice 214 are both in fluid communication with the outlet 130. Thus, fluid from the first pressurized fluid source 122 flows into and through the primary valve chamber inlet flow passage 216, through the primary valve chamber 210, and out the outlet 130.

If the pressure differential between the second pressurized fluid source 124 and the first pressurized fluid source 122 increases, the force exerted against the pilot valve element 234 from the second pressurized fluid source 124 increases. If this force is sufficient to overcome the combined force from the bellows assembly 236 and the first pressurized fluid source 122, the pilot valve element 234 is moved to the second position. In the second position, the pilot valve chamber vent flow passage 224 is isolated from the primary valve chamber 210, and the second pressurized fluid source 124 is in fluid communication with a portion 238 of the primary valve chamber 210. Thus, fluid from the second pressurized fluid source 124 flows through the connecting flow passage 240 and into the portion 238 of the primary valve chamber 210, thereby exerting a closing force against the poppet 230. When the closing force overcomes the bias force exerted against the poppet 230 by the spring 232, the poppet 230 moves to the closed position. In this state, the primary valve chamber inlet flow passage outlet port 217 is isolated from the outlet 130, while the flow restriction orifice 214 maintains a limited amount of vent flow to the outlet 130. This state is depicted in phantom in FIG. 2.

The VCV assembly 102 remains in the above-described state until the pressure differential between the second pressurized fluid source 124 and the first pressurized fluid source 122 decreases sufficiently so that the force exerted against the pilot valve element 234 from the second pressurized fluid source 124 is overcome by the combined force exerted against the pilot valve element 234 in the opposite direction from the first pressurized fluid source 122 and the bellows assembly 236. When this occurs, the pilot valve element 234 moves back to the first position, isolating the second pressurized fluid source 124 from the primary valve chamber 210, and placing the primary valve chamber 210 in fluid communication with the pilot valve chamber vent line 224. As a result, the closing force is overcome by the bias force exerted against the poppet 230 by the spring 232, and the poppet 230 moves back to the open position, as depicted in FIG. 2 and described above.

The VCV assembly 102 can be useful in controlling oil sump pneumatic pressure across bearing seals in various types of bearing cavities of gas turbine engines, such as the bearing lubrication system depicted in FIG. 1. The VCV assembly 102 further helps to prevent oil mist from contaminating the pneumatic inlet fluids which could otherwise lead to undesirable coking or other problems. Additionally, as mentioned above, the sharp edges of the first and second seats 244, 246 and 250, 252 help to cut through any oil contamination buildup, provide enhanced sealing, and prevent reverse inlet pressure flow into the pilot valve 206 from the first fluid source 122. Contamination is further minimized because a non-flowing device, namely the bellows assembly 236, helps to sense inlet pressure without leakage, and because the connecting flow passage 220 is protected by the screen 242. The primary valve 204 and the pilot valve 206 are able to move between positions according to a predetermined, desirable pressure differential range, in accordance with the calibration of the bellows assembly 236 and the spring 232, thereby increasing precision and flexibility for various operating environments and conditions, while minimizing actuation tolerance and reducing leakage. The VCV assembly 102 configuration, for example with the primary valve 204 referenced to outlet pressure, further allows for maximum closing force under minimum operating pressure conditions, and for rapid opening during an engine throttle chop to prevent pressure reversal of bearing cavity seals. Additionally, the VCV assembly 102 is fully contained, with no external venting or leakage, with valves referenced to outlet pressure using internal porting. Also, because the primary valve 204 is pilot operated, this optimizes force margin to overcome friction and/or wear due to contamination and/or coking.

The VCV assembly 102 is able to provide these and other potential benefits while operating in a high temperature environment typically encountered in gas turbine engines. It will be appreciated that certain features of the VCV assembly 102 may vary from those depicted in FIGS. 2 and 3 and described above, and that the VCV assembly 102 can be used in connection with not only the bearing lubrication system 100 of FIG. 1 and variations thereof, but also in connection with any number of other different types of systems and devices.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. A valve assembly comprising:
a valve body including a first inlet flow passage, a second inlet flow passage, a flow restriction orifice, an outlet flow passage, and an inner surface that defines a primary valve chamber, the first inlet flow passage having an inlet port to receive fluid flow from a first pressurized fluid source and an outlet port in fluid communication with the primary valve chamber, the flow restriction orifice adapted to receive fluid flow from the first pressurized fluid source, and the second inlet flow passage adapted to receive fluid flow from a second pressurized fluid source;
a primary valve disposed in the primary valve chamber and configured to move between an open position, in which the first inlet flow passage outlet port and the flow restriction orifice are both in fluid communication with the outlet flow passage, and a closed position, in which the first inlet flow passage outlet port is fluidly isolated from the outlet flow passage and the flow restriction orifice is in fluid communication with the outlet flow passage; and
a pilot valve disposed in the valve body and movable, at least partially in response to a differential pressure between the first and second pressurized fluid sources, between a first position, in which a portion of the primary valve chamber is in fluid communication with the vent outlet and fluidly isolated from the second pressurized fluid source, and a second position, in which the portion of the primary valve chamber is in fluid communication with the second pressurized fluid source and fluidly isolated from the vent outlet.

2. The valve assembly of claim 1, further comprising:
a spring disposed between the primary valve and the valve body and configured to supply a bias force that urges the primary valve toward the open position.

3. The valve assembly of claim 2, wherein the primary valve includes a poppet configured to receive, in at least substantially opposite directions, a closing force from fluid flow from the second pressurized fluid source, and the bias force from the spring.

4. The valve assembly of claim 3, wherein the primary valve is configured to move:
from the closed position to the open position when the bias force exceeds the closing force; and
from the open position to the closed position when the closing force exceeds the bias force.

5. The valve assembly of claim 1, further comprising:
a connecting channel formed by the inner surface and selectively fluidly connecting the portion of the primary valve chamber, depending on the position of the pilot valve, with the second inlet flow passage or the vent outlet.

6. The valve assembly of claim 1, wherein the pilot valve is configured to move from the first position to the second position when a second force received from the second pressure source exceeds a first force received from the first pressure source by at least a predetermined magnitude.

7. The valve assembly of claim 6, further comprising:
a bellows assembly coupled to the pilot valve and configured to supply a bias force urging the pilot valve toward the first position.

8. The valve assembly of claim 7, wherein the pilot valve is configured to move:
from the first position to the second position when the second force exceeds the sum of the first force and the bias force; and
from the second position to the first position when the sum of the first force and the bias force exceeds the second force.

9. The valve assembly of claim 1, further comprising:
a screen formed by the inner surface inside the second inlet flow passage.

10. The valve assembly of claim 1, further comprising:
a first seat formed by the inner surface that seats the pilot valve when the pilot valve is in the first position; and
a second seat formed by the inner surface that seats the pilot valve when the pilot valve is in the second position.

11. The valve assembly of claim 10, wherein the first seat and the second seat each have a sharp edge.

12. The valve assembly of claim 1, further comprising:
a first primary valve seat formed by the inner surface that seats the primary valve when the primary valve is in the open position; and
a second primary valve seat formed by the inner surface that seats the primary valve when the primary valve is in the closed position.

13. The valve assembly of claim 12, wherein the first primary valve seat and the second primary valve seat each have a sharp edge.

14. The valve assembly of claim 1, wherein the valve assembly is fully contained, with no external venting or leakage.

15. A valve assembly comprising:
a valve body including a first inlet flow passage, a second inlet flow passage, a third inlet flow passage, a flow restriction orifice, an ambient vent, an outlet flow passage, and an inner surface that defines a primary valve chamber, the first inlet flow passage having an inlet port adapted to receive fluid flow from a first pressurized fluid source and an outlet port in fluid communication with the primary valve chamber, the flow restriction orifice and the second inlet flow passage adapted to receive fluid flow from the first pressurized fluid source, and the third inlet flow passage adapted to receive fluid flow from a second pressurized fluid source;
a primary valve disposed in the primary valve chamber and configured to move between an open position, in which the first inlet flow passage outlet port and the flow restriction orifice are both in fluid communication with the outlet flow passage, and a closed position, in which the first inlet flow passage outlet port is fluidly isolated from the outlet flow passage and the flow restriction orifice is in fluid communication with the outlet flow passage; and
a pilot valve disposed in the valve body and movable, at least partially in response to a differential pressure between the first and second pressurized fluid sources, between a first position, in which a portion of the primary valve chamber is in fluid communication with the vent outlet and fluidly isolated from the second pressurized fluid source, and a second position, in which the portion of the primary valve chamber is in fluid communication with the second pressurized fluid source and fluidly isolated from the vent outlet.

16. The valve assembly of claim 15, further comprising:
a spring disposed between the primary valve and the valve body and configured to supply a bias force that urges the primary valve toward the open position.

17. The valve assembly of claim 16, wherein:
the primary valve includes a poppet at least partially defining the portion of the primary valve chamber and configured to receive, in at least substantially opposite directions, a closing force from fluid flow from the second pressurized fluid source, and the bias force from the spring; and
the primary valve is configured to move:
from the closed position to the open position when the bias force exceeds the closing force; and
from the open position to the closed position when the closing force exceeds the bias force.

18. The valve assembly of claim 17, wherein the pilot valve is configured to move from the first position to the second position when a second force received from the second pressure source exceeds a first force received from the first pressure source by at least a predetermined magnitude.

19. The valve assembly of claim 18, further comprising:
a bellows assembly coupled to the pilot valve and configured to supply a bias force urging the pilot valve toward the first position;
wherein the pilot valve is configured to move:
from the first position to the second position when the second force exceeds the sum of the first force and the bias force; and
from the second position to the first position when the sum of the first force and the bias force exceeds the second force.

20. A valve assembly for controlling pressure between a first pressurized fluid source and a second pressurized fluid source, the valve assembly comprising:
a valve body including a first inlet flow passage, a second inlet flow passage, a flow restriction orifice, a vent line, an outlet flow passage, and an inner surface that defines a primary valve chamber, the first inlet flow passage having an inlet port adapted to receive fluid flow from the first pressurized fluid source and an outlet port in fluid communication with the primary valve chamber, the flow restriction orifice adapted to receive fluid flow from the first pressurized fluid source, and the second inlet flow passage adapted to receive fluid flow from the second pressurized fluid source;
a primary valve disposed at least partially in the primary valve chamber, the primary valve including:
a spring disposed in the valve body; and
a poppet disposed in the primary valve chamber and configured to receive, in at least substantially opposite directions, a closing force from fluid flow from the second pressurized fluid source, and a bias force from the spring, the poppet movable by the opposing closing force and bias force between an open position, in which the first inlet flow passage outlet port and the flow restriction orifice are both in fluid communication with the outlet flow passage, and a closed position, in which the first inlet flow passage outlet port is fluidly isolated from the outlet flow passage and the flow restriction orifice is in fluid communication with the outlet flow passage; and
a pilot valve disposed in the valve body and including a pilot valve element movable, at least partially in response to a differential pressure between the first and second pressurized fluid sources, between a first position, in which a portion of the primary valve chamber is in fluid communication with the vent outlet and fluidly isolated from the second pressurized fluid source, and a second position, in which the portion of the primary valve chamber is in fluid communication with the second pressurized fluid source and fluidly isolated from the vent outlet.
